(19) United States
(12) Patent Application Publication
(10) Pub. No.: US 2026/0140055 A1
(43) Pub. Date: May 21, 2026

(54) LASER-INDUCED RAMAN AND FLUORESCENCE SPECTROSCOPIC TEST SYSTEM

(71) Applicant: Xinghai CHEN, Beijing (CN)

(72) Inventor: Xinghai CHEN, Beijing (CN)

(21) Appl. No.: 19/372,144

(22) Filed: Oct. 28, 2025

Related U.S. Application Data
(63) Continuation of application No. PCT/CN2024/132156, filed on Nov. 15, 2024.

(51) Int. Cl. G01N 21/64; G01N 21/65

(52) U.S. Cl. CPC G01N 21/645; G01N 21/658; G01N 2021/6417; G01N 2021/6463; G01N 2021/6482; G01N 2201/06113

(57) ABSTRACT

A laser-induced Raman and fluorescence spectroscopic test system includes a laser module, a harmonic beamsplitter, a frequency-doubling crystal, a first cavity mirror, a sample cell, a second cavity mirror, and a spectroscopic detection unit. A laser beam output by the laser module sequentially passes through the harmonic beamsplitter, the frequency-doubling crystal, and the first cavity mirror. Two sides of the harmonic beamsplitter are plated with a highly transmissive film and a highly reflective film, and the harmonic beamsplitter reflects a laser beam of a required wavelength to the sample cell. The second cavity mirror is configured for returning a laser beam from the sample cell. The harmonic beamsplitter, the first cavity mirror, the second focusing lens, and the second cavity mirror form a dual-beam waist laser resonator cavity. The first cavity mirror and the second cavity mirror are spherical mirrors and are plated with different highly reflective films.

### CROSS-REFERENCE TO RELATED APPLICATIONS

This application is a continuation of International Application No. PCT/CN2024/132156, filed on Nov. 15, 2024, the content of which is incorporated herein by reference in its entirety.

### TECHNICAL FIELD

The present application relates to the field of spectroscopic test technology, and in particular, to a laser-induced Raman and fluorescence spectroscopic test system.

### BACKGROUND

With the continuous development of laser technology, the application range of the Raman and fluorescence detection technology using laser beams as the excitation source is becoming broader. In practice, there are various detection objects, and laser beams can be used as the excitation source for Raman and fluorescent signal detection for solids, liquids, and gases.

Conventional Raman and fluorescence detection systems mostly use a spot excitation/spot collection test method. That is, the laser beam is focused on a sample of interest, and then the fluorescent or scattered (Raman, Rayleigh) signals generated by the excitation of the laser beam spot on the sample are collected to a spectroscopic signal measurement device for detection through a collection optical path. In existing laser-excited Raman and fluorescence spectroscopic test systems, the excitation and collection optical paths are applicable to non-transparent samples such as solid and powder samples, while for transparent substances such as gas and liquid, the absorption and scattering cross-sections of the excitation light are insufficient, leading to weak excited fluorescent or Raman signals. Especially for gas samples, the excitation efficiency needs to be improved by multiple reflections, increased pressure, etc.

In order to solve the above problems, in a first existing solution, the Raman signals of gases are increased by using a hollow photonic-crystal fiber. The excitation light is focused into the hollow photonic-crystal fiber, and the gas of interest is introduced into the fiber at a normal or increased pressure. The laser beam is reflected multiple times in the fiber to excite the gas. The generated Raman scattering signal is also reflected multiple times in the fiber and then emitted through the fiber outlet, received by the collection lens, and detected by the spectroscopic detector. Since the core diameter of the photonic-crystal fiber is usually several microns, this technical solution generally requires the use of a micro-Raman optical system to couple the laser beam to the fiber through a microscopic objective lens, which results in relatively high system costs and debugging difficulties. The laser beam directed into the fiber through the coupling may easily ablate the cut surface of the fiber. The fiber frequently requires recutting and the adjustment of the coupling optical path. The hollow photonic-crystal fiber is not one of the conventional batch products, but one supplied by only a few facilities at a high cost. It can only be used for gas detection, but is not suitable for liquids. Also, the hollow photonic-crystal fiber can only be used for collecting and detecting the signal light satisfying the total reflection in the fiber in the transmission direction of the laser beam.

In a second existing solution, a multi-reflection cavity is used to increase the Raman signals. The multi-reflection cavity can effectively prolong the interaction time between the laser beam and gas molecules by reflecting the laser beam between the cavity mirrors multiple times, and can achieve signal detection by collecting the Raman or fluorescence spectroscopy signals generated by the action of the laser beam and the substance in the same direction as the laser beam transmission. In this technical solution, the reflectivity of the multi-reflection cavity mirror with no gains directly determines the times of reflection of the laser beam in the cavity, and the gain efficiency can only be improved by increasing the laser beam power and reflectivity, usually achieving a gain output of only dozens of times. The multi-reflection cavity should be filled with the detection substance, thus requiring a great amount of the substance. Only signals in the same direction as the transmission optical path of the laser beam can be collected, resulting in a low signal collection efficiency. Generally, the method is only suitable for gas detection.

In a third existing solution, a multi-reflection cavity is used to increase the Raman signals. Similar to the second solution, a laser beam passes through a confocal cavity and is reflected through a focal point of the confocal cavity, and the signal detection is achieved by collecting a spectrum generated by the action of the laser beam and the substance at the position of the focal point. Compared with the second solution, the confocal cavity collects a signal generated at the focal point, which requires a small amount of sample. However, in this technical solution, there are no gains in the cavity, and the structure and reflectivity of the confocal cavity directly determine the times of reflection of the laser beam in the cavity. The gain efficiency can be improved only by increasing the laser beam power and reflectivity, usually achieving a gain output of only dozens of times. The multi-reflection enhancement can only be achieved on signals at the focal point.

In view of this, there is an urgent need for a laser-induced Raman and fluorescence spectroscopic test system.

### SUMMARY

In view of the problems in the prior art, the present application uses the following technical structure to solve the problem.

In order to realize the objective, the present application adopts the following technical solutions.

Provided is a laser-induced Raman and fluorescence spectroscopic test system, including: a laser module, a harmonic beamsplitter, a frequency-doubling crystal, a first cavity mirror, a sample cell, a second cavity mirror, and a spectroscopic detection unit, where
a laser beam output by the laser module sequentially passes through the harmonic beamsplitter, the frequency-doubling crystal, and the first cavity mirror;
the side of the harmonic beamsplitter proximal to the laser module is plated with a highly transmissive film, the side of the harmonic beamsplitter proximal to the frequency-doubling crystal is plated with a highly reflective film, and the harmonic beamsplitter separates a laser beam from the frequency-doubling crystal and reflects a laser beam with a required wavelength to the sample cell;
the first cavity mirror is configured for reflecting a laser beam from the frequency-doubling crystal to the frequency-doubling crystal;
the second cavity mirror is configured for reflecting a laser beam from the sample cell to the sample cell;
the spectroscopic detection unit is configured for performing analysis and detection on a sample in the sample cell.

Moreover, the laser module includes a pump laser, a wave plate, and a first focusing lens, and a laser beam output by the pump laser sequentially passes through the wave plate, the first focusing lens, and the harmonic beamsplitter.

A Faraday optical isolator is arranged between the pump laser and the wave plate.

The wave plate is a half-wave plate.

A second focusing lens is arranged between the harmonic beamsplitter and the sample cell.

The system further includes a collection mirror configured for collecting and reflecting scattered or fluorescent signals generated by the sample, a collimating lens configured for collimating the scattered and fluorescent signals from the sample cell, and a laser beam filter, where the collimated laser beam passes through the laser beam filter and enters the spectroscopic detection unit.

The system further includes a third focusing lens configured for focusing the laser beam entering the spectroscopic detection unit.

The spectroscopic detection unit includes a slit, a collimator, a disperser, and an area array detector, and a laser beam from the sample sequentially passes through the slit, the collimator, the disperser, and the area array detector.

The spectroscopic detection unit further includes a fourth focusing lens, and the fourth focusing lens is arranged between the disperser and the area array detector.

The spectroscopic detection unit includes a linear array detector.

The above structure of the present application can achieve the following beneficial effects.

The harmonic beamsplitter, the first cavity mirror, the second focusing lens, and the second cavity mirror form a dual-beam waist laser resonator cavity. The first cavity mirror and the second cavity mirror are spherical mirrors and are plated with different highly reflective films. The first cavity mirror is confocal to the first focusing lens, and the second cavity mirror is confocal to the second focusing lens. The focal points of the two beam waist of the laser resonator cavity are located at the frequency-doubling crystal and the sample cell to achieve optimal frequency-doubling efficiency and sample excitation efficiency.

### BRIEF DESCRIPTION OF THE DRAWINGS

FIG. 1 is a structural schematic diagram of according to Example 1 of the present application;

FIG. 2 is a structural schematic diagram of according to Example 2 of the present application;

FIG. 3 is a structural schematic diagram of according to Example 3 of the present application.

### DETAILED DESCRIPTION OF THE EMBODIMENTS

To enable those skilled in the art to better understand the solutions of the present application, the technical solutions in the examples of the present application will be clearly and thoroughly described below in conjunction with the accompanying drawings in the examples of the present application. It is apparent that the described examples are merely part of the examples of the present application and not all of the examples. Based on the examples of the present application, all other examples obtained by those of ordinary skill in the art without creative efforts shall fall within the protection scope of the present application.

It should be noted that the terms “comprise/include” and “have” in the specification, claims, and the above accompanying drawings of the present application, as well as any variations thereof, are intended to cover non-exclusive inclusion. For example, a process, method, device, product, or apparatus that includes a series of steps or units is not necessarily limited to those steps or units explicitly listed but may include additional steps or units not expressly listed or inherently included in such a process, method, product, or apparatus.

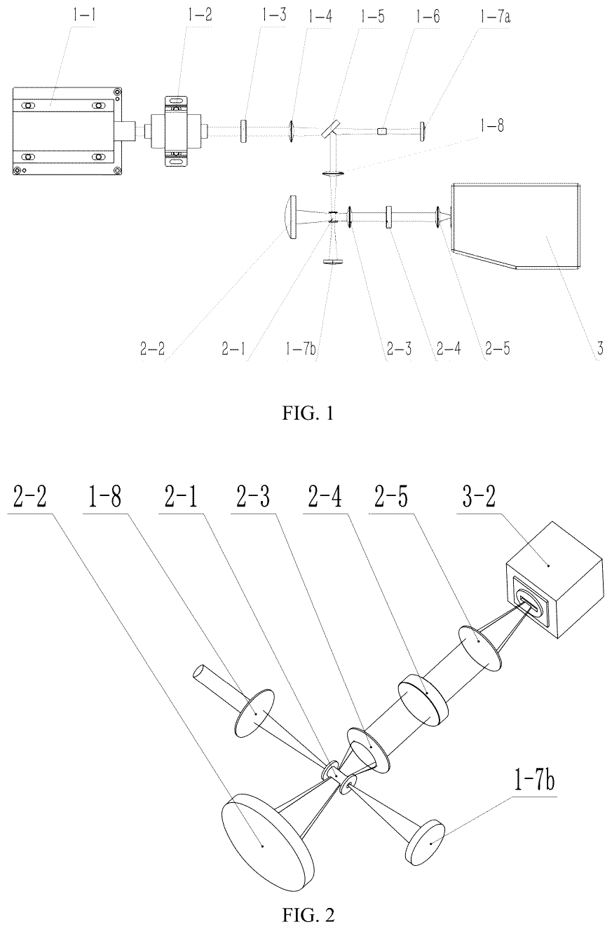

The present application is further illustrated in detail below with reference to FIGS. 1 to 3.

In Example 1, referring to FIG. 1, a laser-induced Raman and fluorescence spectroscopic test system includes a laser module, a harmonic beamsplitter 1-5, a frequency-doubling crystal 1-6, a first cavity mirror 1-7a, a sample cell 2-1, a second cavity mirror 1-7b, and a spectroscopic detection unit 3. A laser beam output by the laser module sequentially passes through the harmonic beamsplitter 1-5, the frequency-doubling crystal 1-6, and the first cavity mirror 1-7a. The two sides of the harmonic beamsplitter 1-5 in the laser transmission direction (the direction from the laser module to the frequency-doubling crystal 1-6) are respectively plated with a highly transmissive film and a highly reflective film. The harmonic beamsplitter 1-5 separates a laser beam from the frequency-doubling crystal 1-6 and reflects a laser beam with a required wavelength to the sample cell 2-1, and a second focusing lens 1-8 is arranged between the harmonic beamsplitter 1-5 and the sample cell 2-1. The first cavity mirror 1-7a is configured for reflecting a laser beam from the frequency-doubling crystal 1-6 to the frequency-doubling crystal 1-6, and the second cavity mirror 1-7b is configured for reflecting a laser beam from the sample cell 2-1 to the sample cell 2-1. The spectroscopic detection unit 3 is configured for performing analysis and detection on a sample in the sample cell 2-1. The laser module includes a pump laser 1-1, a Faraday optical isolator 1-2, a wave plate 1-3, and a first focusing lens 1-4, and a laser output by the pump laser 1-1 sequentially passes through the Faraday optical isolator 1-2, the wave plate 1-3, the first focusing lens 1-4, and the harmonic beamsplitter 1-5. The wave plate 1-3 is a half-wave plate.

Based on the above structure, the output laser beam from the pump laser 1-1 sequentially passes through the Faraday optical isolator 1-2, the wave plate 1-3, the first focusing lens 1-4, the harmonic beamsplitter 1-5, and the frequency-doubling crystal 1-6, and finally reaches the first cavity mirror 1-7a. After the laser beam reaches the frequency-doubling crystal 1-6, it converts the laser beam into a frequency-doubled beam thereof (converting a laser beam with a specific wavelength into a laser beam with a halved wavelength). Then the laser beam reaches the first cavity mirror 1-7a. The frequency-doubled laser beam and the remaining laser beam with the original wavelength are reflected by the first cavity mirror 1-7a to the frequency-doubling crystal 1-6, and pass through the frequency-doubling crystal 1-6 and reach the harmonic beamsplitter 1-5. Then, since the harmonic beamsplitter 1-5 is plated with the highly reflective film and the highly transmissive film, the frequency-doubled laser beam is reflected to the sample cell 2-1, and the remaining laser beam returns through the highly transmissive film along the original path. The second cavity mirror 1-7b is arranged on the opposite side of the harmonic beamsplitter 1-5, and the laser beam from the sample cell 2-1 is reflected to the sample cell 2-1, thus achieving the return of the laser beam and thereby multiplying the energy of the laser beam with the required wavelength.

As shown in FIG. 1, this example further includes a collection mirror 2-2 configured for collecting and reflecting scattered or fluorescent signals generated by the sample, a collimating lens 2-3 configured for collimating the scattered and fluorescent signals at the sample cell 2-1, a laser beam filter 2-4, and a third focusing lens 2-5. The collimated laser beam enters the spectroscopic detection unit 3 through the laser beam filter 2-4. The third focusing lens 2-5 is configured for focusing the laser beam that is about to enter the spectroscopic detection unit 3. As such, the laser beam reflected by the harmonic beamsplitter 1-5 reaches the sample cell 2-1, and the gas or liquid sample in the sample cell 2-1 is excited by the laser beam to generate scattered or fluorescent signals. The collection mirror 2-2 and the spectroscopic detection unit 3 are arranged on opposite sides of the sample cell 2-1, and the scattered or fluorescent signals generated by the sample at the sample cell 2-1 are collected and reflected to the sample cell 2-1 by the collection mirror 2-2, and reach the collimating lens 2-3, so as to reduce the loss of the scattered or fluorescent signals generated by the gas or liquid sample in the sample cell 2-1 after being excited by the laser beam and achieve the gain of the laser beam with the required wavelength. The signal from the sample cell 2-1 is collimated by the collimating lens 2-3, filtered through the laser beam filter 2-4, and finally focused into the spectroscopic detection unit 3 through the third focusing lens 2-5.

The following provides a detailed description by taking an example of a 532 nm laser beam output by frequency doubling of a 1064 nm pump laser for excitation:

The laser beam output by the 1064 nm pump laser 1-1 passes through the Faraday optical isolator 1-2, the ¼ λ wave plate 1-3, the first focusing lens 1-4, and the harmonic beamsplitter 1-5, and is then focused to the frequency-doubling crystal 1-6 to generate the 532 nm laser beam. The Faraday optical isolator 1-2 is configured for isolating the 1064 nm laser beam reflected by the first cavity mirror 1-7a from entering the pump laser 1-1 to avoid damage to the pump laser 1-1. The wave plate 1-3 (a wave plate with a wavelength of ¼ λ is selected in this example) is configured for adjusting the polarization direction of the laser beam to achieve phase matching with the frequency-doubling crystal 1-6 to achieve the best frequency-doubling efficiency. The two sides of the harmonic beamsplitter 1-5 are separately plated with a 1064 nm highly transmissive film and a 532 nm highly reflective film to achieve the transmission of the pumped 1064 nm laser beam and high reflection of the frequency-doubled 532 nm laser beam. The 532 nm laser beam generated by the 1064 nm laser beam passing through the frequency-doubling crystal 1-6 and the remaining 1064 nm laser beam are reflected by the first cavity mirror 1-7 a and then pass through the frequency-doubling crystal 1-6. The harmonic beamsplitter 1-5 separates the 532 nm laser beam from the 1064 nm laser beam. The 1064 nm laser beam returns to the pump laser 1-1 along the original optical path, and the 532 nm laser beam is reflected and focused to the sample cell 2-1 through the second focusing lens 1-8, and then is reflected by the second cavity mirror 1-7b and returned along the original optical path. The harmonic beamsplitter 1-5, the first cavity mirror 1-7a, the second focusing lens 1-8, and the second cavity mirror 1-7 b form a dual-beam waist 532 nm laser resonator cavity. The first cavity mirror 1-7a and the second cavity mirror 1-7b are spherical mirrors plated with 532 nm and 1064 nm highly reflective films, respectively. The first cavity mirror 1-7a is confocal to the first focusing lens 1-4, and the second cavity mirror 1-7b is confocal to the second focusing lens 1-8. The focal points of the two beam waist of the 532 nm laser resonator cavity are located at the frequency-doubling crystal 1-6 and the sample cell 2-1 to achieve optimal frequency-doubling efficiency and sample excitation efficiency.

In the foregoing system structure, a 532 nm laser beam generated by frequency doubling of a 1064 nm laser beam in a crystal in a resonator cavity can be resonated in the cavity to achieve power multiplication. When the power of the 532 nm laser beam in the cavity and the power of the 532 nm laser beam generated by frequency doubling of the 1064 nm laser beam are the same as the intracavity loss, stability is achieved. The intracavity 532 nm laser beam power can be multiplied by orders of magnitude by increasing the 1064 nm pumping power and the frequency-doubling efficiency and controlling the intracavity losses (reflection and diffraction losses at the intracavity devices and absorption and scattering losses of a sample). Certainly, the 532 nm laser beam output by the frequency doubling of 1064 nm pump laser is only exemplary, and this method can also enhance the intracavity gain of other excitation wavelengths. For example, a pumped laser beam is 1570 nm, and the frequency doubling achieves the intracavity resonance of a 785 nm laser beam. Alternatively, the frequency-doubling crystal may be changed to a laser crystal such as a YAG crystal, and the intracavity enhancement of a 1064 nm laser beam may be achieved by a 808 nm pump laser.

In Example 2, as shown in FIG. 2, the spectroscopic detection unit 3 includes a slit 3-1-1, a collimator 3-1-2, a disperser 3-1-3, and an area array detector 3-1-5. A laser beam from a sample sequentially passes through the slit 3-1-1, the collimator 3-1-2, the disperser 3-1-3, a fourth focusing lens 3-1-4, and the area array detector 3-1-5. The third focusing lens 2-5 focuses the signal light to the slit 3-1-1, and then the signal beam is collimated by the collimator 3-1-2, and diffracted and split by the disperser 3-1-3. Then the fourth focusing lens 3-1-4 focuses signal beams with different wavelengths to the Y direction of the area array detector 3-1-5. The Y direction of the area array detector 3-1-5 corresponds to signals of different wavelengths, and the X direction corresponds to spatial dimension information in the length direction of the slit 3-1-1. That is, each column of the area array detector 3-1-5 corresponds to the spectral information of a spot in the length direction of the slit 3-1-1, and the detector signal is accumulated and integrated in the X direction (in the X direction, that is, corresponding to the length direction of the slit 3-1-1, the signal is accumulated to achieve the integral enhancement of the signal), such that the linear integral detection of the scattered or fluorescent signal generated by the laser linear excitation can be achieved, thereby improving the signal intensity and the detection sensitivity. Each spot can also be detected separately to achieve linear imaging and counting detection of signals on the excitation line, such as the detection of microplastics in a solution, particles in a gas, abnormal cells in the blood, etc.

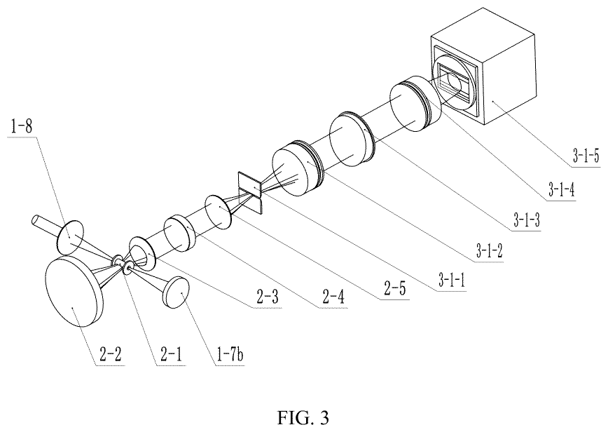

In Example 3, as shown in FIG. 3, in addition to the above spectroscopic detection unit, the spectroscopic detection unit of the present application may also adopt a linear array detector to achieve the signal detection of specific wavelengths of the spectroscopic signal generated by the linear excitation after passing through the optical filter.

In summary, in the present application, the gain resonance method implemented in the resonator cavity is used to multiply the energy of the excitation light by orders of magnitude. In addition, by using the linear transmission characteristics of the laser beam and the weak absorption and scattering characteristics in the laser beam in gases and liquids, as well as the slit imaging characteristics of the imaging spectrometer, the linear excitation/linear collection method is used to greatly improve the sample excitation and signal detection capabilities. The present application is applicable to non-transparent samples such as solid and powder samples, and applicable to transparent substances such as gases and liquids, thus featuring ease to implement. In addition, compared with the prior art, the present application features cost-efficiency, intracavity gains, smaller sample amounts, and high signal collection efficiency.

The above are only preferred embodiments of the present application, and the present application is not limited to the above examples. It will be appreciated that other modifications and variations directly derived or expected by those skilled in the art without departing from the spirit and scope of the present application shall be construed as falling within the scope of the present application.

What is claimed is:

1. A laser-induced Raman and fluorescence spectroscopic test system, comprising: a laser module, a harmonic beamsplitter, a frequency-doubling crystal, a first cavity mirror, a sample cell, a second cavity mirror, and a spectroscopic detection unit, wherein
a laser beam output by the laser module sequentially passes through the harmonic beamsplitter, the frequency-doubling crystal, and the first cavity mirror;
a side of the harmonic beamsplitter proximal to the laser module is plated with a highly transmissive film, a side of the harmonic beamsplitter proximal to the frequency-doubling crystal is plated with a highly reflective film, and the harmonic beamsplitter separates a laser beam from the frequency-doubling crystal and reflects a laser beam with a required wavelength to the sample cell;
the first cavity mirror is configured for reflecting a laser beam from the frequency-doubling crystal to the frequency-doubling crystal;
the second cavity mirror is configured for reflecting a laser beam from the sample cell to the sample cell; and
the spectroscopic detection unit is configured for performing analysis and detection on a sample in the sample cell.

2. The laser-induced Raman and fluorescence spectroscopic test system according to claim 1, wherein the laser module comprises a pump laser, a wave plate, and a first focusing lens, and a laser beam output by the pump laser sequentially passes through the wave plate, the first focusing lens, and the harmonic beamsplitter.

3. The laser-induced Raman and fluorescence spectroscopic test system according to claim 2, wherein a Faraday optical isolator is arranged between the pump laser and the wave plate.

4. The laser-induced Raman and fluorescence spectroscopic test system according to claim 2, wherein the wave plate is a half-wave plate.

5. The laser-induced Raman and fluorescence spectroscopic test system according to claim 1, wherein a second focusing lens is arranged between the harmonic beamsplitter and the sample cell.

6. The laser-induced Raman and fluorescence spectroscopic test system according to claim 1, further comprising: a collection mirror configured for collecting and reflecting scattered or fluorescent signals generated by the sample, a collimating lens configured for collimating the scattered and fluorescent signals from the sample cell, and a laser beam filter, wherein the collimated laser beam passes through the laser beam filter and enters the spectroscopic detection unit.

7. The laser-induced Raman and fluorescence spectroscopic test system according to claim 6, further comprising: a third focusing lens arranged between the laser beam filter and the spectroscopic detection unit.

8. The laser-induced Raman and fluorescence spectroscopic test system according to claim 1, wherein the spectroscopic detection unit comprises a slit, a collimator, a disperser, and an area array detector, and a laser beam from the sample sequentially passes through the slit, the collimator, the disperser, and the area array detector.

9. The laser-induced Raman and fluorescence spectroscopic test system according to claim 8, wherein the spectroscopic detection unit further comprises a fourth focusing lens, and the fourth focusing lens is arranged between the disperser and the area array detector.

10. The laser-induced Raman and fluorescence spectroscopic test system according to claim 1, wherein the spectroscopic detection unit comprises a linear array detector.
